(19) United States
(12) Patent Application Publication
(10) Pub. No.: US 2006/0018361 A1
(43) Pub. Date: Jan. 26, 2006

(54) Sensor and method for making same

(76) Inventors: Canan Uslu Hardwicke, Niskayuna, NY (US); Stephen Francis Rutkowski, Duanesburg, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/897,786

(22) Filed: Jul. 23, 2004

(51) Int. Cl. H01C 3/04

(52) U.S. Cl. 374/141; 338/25

(57) ABSTRACT

Multi-layer sensors are made using a direct write deposition technology. The sensors are formed on the surface of an object having a system characteristic to be monitored, such as temperature and strain. A first layer is deposited onto the substrate of the object to be monitored, a second layer is deposited onto the first layer, and a third layer is deposited onto the second layer. An optional protective layer may be deposited between the first layer and the substrate to prevent chemical interaction and lack of adhesion therebetween. A glazing or glassing layer may also be deposited to protect the thermistor from the operating environment to keep its electrical properties constant. These layers are sintered together, then electrical leads are attached to the sensor and to a monitoring controller. The monitoring controller may be hardwired to the sensor or remote therefrom.

### BACKGROUND

The invention relates generally to methods for making sensors and more particularly to methods for direct writing a multi-layer sensor onto the object to be monitored.

Many machine components operate in harsh environments, such as regions of high temperature, pressure, or mechanical strain within a machine or the machine's external environment. For example, gas turbine engines operate at extremely high temperatures. In recent years, the operating temperature of gas turbine engines has been increasing in order to increase their efficiency. Operating temperatures approaching and exceeding 1000 degrees centigrade are not unusual. As the operating temperature of components such as gas turbine engine blades nears the design limit for the materials used to manufacture the blades, the temperature of the blades must be monitored in real time to avoid failure. Other system properties of the turbine engine blade, such as strain, may also need to be monitored.

In another example, catalytic converters for automobiles begin to operate at around 288 degrees centigrade and achieve efficient purification of the exhaust stream at around 400 degrees centigrade. Unnecessarily high combustion temperature can reduce fuel efficiency and increase emission pollution. Therefore, the inlet and outlet temperatures of a catalytic converter should be monitored to maintain the temperature at around 400 degrees centigrade to assure fuel burn efficiency.

Often, the location of the component within the complex engine configuration makes the placement of a conventional sensor impractical or inconvenient. One known method for real-time sensing of such components is to transform the conventional material from which the object to be monitored is made into a so-called “smart material”. A smart material is a material capable of sensing its own system property such as temperature and providing a signal so that the system property may be monitored. For example, grooves are cut into the surface of a turbine engine blade, and wire thermocouples are then embedded within the grooves. The grooves are then filled with a high-temperature dielectric material. However, these grooves on the surface compromise structural integrity of the component, risking the real-time, long term data collection. Another example of integrating sensors into a component is depositing thin film thermocouples on the surface of the component. The current process is expensive and slow, as the process is extremely labor intensive, requiring as much as several weeks to manufacture each sensor due to the need to polish the surface prior to applying the thin films using a vacuum deposition procedure.

Thermistors are also used to measure the temperature of complex machinery components, usually for temperatures less than 200 degrees centigrade. Thermistors are thermally sensitive resistors that exhibit large, predictable and precise changes in electrical resistance when subjected to a corresponding change in temperature. A basic thermistor sensor includes a semiconductor material whose resistance is a function of temperature (hereinafter, “thermistor material” ) sandwiched between two conductive materials. Electrical connection leads provide a current to one of the conductive materials, and the current reaching the other conductive material is measured.

Rare earth oxide compositions are used in high temperature thermistors, i.e., thermistors whose properties are stable in temperatures exceeding 1000 degrees centigrade, such as those described in U.S. Pat. No. 6,204,748, the disclosure of which is incorporated herein by reference in its entirety. Currently, the procedure for making a high temperature thermistor is an intensive process. The processing steps include molding and pressing thermistor powder into pellets, sintering the pellets, applying the electrical contacts, grinding the pellets into the desired shape, sorting the resultant parts by resistance, re-grinding and re-sorting the parts as necessary, attaching electrical leads to the contacts, and overcoating with a suitable glaze. Eliminating the grinding and sorting steps would significantly increase manufacturing efficiencies. Further, consistency of manufacturing without needing to retool to achieve appropriate results would greatly reduce the manufacturing time.

Deposition technologies for manufacturing thin films are one known method for making sensors. Direct write deposition is a cost-effective process for the deposition of films of thickness on the order of 1 micrometer to 300 micrometers. As known in the art, direct write deposition technologies are used for many purposes, including writing circuitry on circuit boards. Direct write deposition involves the preparation of a slurry or “ink” including a powder of the material to be deposited. A dispensing system deposits the ink in a very controlled manner onto a substrate, which is then aged, hardened, and/or sintered. While the deposition technology can only deposit thin films, direct write deposition may be used to form objects by dispensing and hardening successive layers of the object. Such a process is described in commonly owned, co-pending U.S. application Ser. No. 10/326,618 filed on Dec. 23, 2002, the disclosure of which is hereby incorporated by reference in its entirety. The process also allows processing of many different sensor designs, which in turn might provide better properties such as stability with time at temperature. Compared to the other sensor fabrication processes, the material usage is virtually 100% in the direct write deposition process, and sensor dimensions less than 100 micrometers can be processed repeatably.

It would therefore be desirable to simplify the integration of a monitoring system with a system component using a direct write manufacturing process.

### SUMMARY

Briefly, in accordance with one embodiment of the invention, a method for making a sensor is provided that includes depositing a first layer of the sensor onto a substrate using a direct write technology, and depositing a second layer of the sensor upon the first layer using a direct write technology. The method further provides for depositing a third layer of the sensor upon the second layer using a direct write technology, and sintering the first, second, and third layers together.

In accordance with another embodiment of the invention, a method for making a temperature sensor is provided that includes providing an object to be monitored by the sensor; direct writing a protective layer onto the object, direct writing a first conductive layer upon the protective layer, and direct writing a thermistor layer onto the first conductive layer. The method further provides for direct writing a second conductive layer onto the thermistor layer, and sintering all of the layers together. =p In accordance with another embodiment of the invention, a method for manufacturing a sensor includes mixing a first powder with a first solvent and a first binder to form a first ink, forming a first layer by direct writing the first ink onto a substrate, mixing a second powder with a second solvent and a second binder to form a second ink, and forming a second layer by direct writing the second ink onto the first layer. The method further provides for mixing a third powder with a third solvent and a third binder to form a third ink, forming a third layer by direct writing the third ink onto the second layer, sintering the first, second, and third layers together, mixing a fourth powder with a fourth solvent and a fourth binder to form a fourth ink, forming electrical contact leads by direct writing the fourth ink onto at least a portion of the sintered layers, and connecting the electrical contacts to a controller.

In accordance with another embodiment of the invention, a system for real-time monitoring of a system characteristic is provided that includes an object to be monitored, a sensor formed on the object using a direct write process, and a controller functionally connected to the sensor.

These and other features, aspects, and advantages of the invention will become better understood when the following detailed description is read with reference to the accompanying drawings.

### BRIEF DESCRIPTION OF THE DRAWINGS

FIG. 1 shows a perspective view of a system incorporating a sensor made in accordance with an exemplary embodiment of the invention.

FIG. 2 shows a top view of a sensor made in accordance with an exemplary embodiment of the invention.

FIG. 2A shows a cross-sectional view taken along line A-A of the sensor of FIG. 2.

FIG. 3 shows a schematic view of a direct write manufacturing system;

FIG. 4 shows a perspective view of a system incorporating a remote sensor made in accordance with another exemplary embodiment of the invention;

FIG. 5A is a graph of the natural logarithm resistance versus inverse temperature for a conventional thermistor and several thermistors made in accordance with exemplary embodiments of the invention; and

FIG. 5B is a graph of resistance versus temperature for a thermistor made in accordance with an exemplary embodiment of the invention.

### DETAILED DESCRIPTION OF EXEMPLARY EMBODIMENTS

As illustrated in the accompanying drawings and discussed in detail below, an embodiment of the invention, directed to a method of making sensors, resolves the deficiencies of the known prior art discussed above. Such improvements include, but are not limited to, increased efficiency of manufacturing and ease of packaging. Applications for embodiments of the invention are described below and illustrated in the accompanying drawings with respect to manufacturing a system and include a gas turbine engine blade having a high temperature thermistor integrated therewith and a catalytic converter for an internal combustion engine having high temperature thermistors integrated therewith. It should be appreciated however that the embodiments of the invention are not limited to these applications.

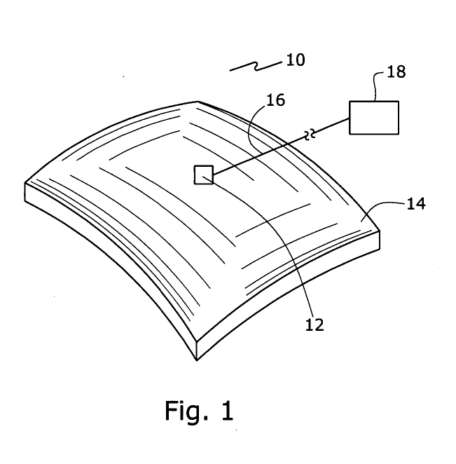

FIG. 1 shows a perspective schematic view of one embodiment of a monitoring system 10 according to an aspect of the invention. Monitoring systems are known in the art, and a similar system is described in commonly owned, co-pending U.S. application Ser. No. 10/065,816, filed Nov. 22, 2002, the disclosure of which is hereby incorporated by reference in its entirety. A sensor 12 is disposed upon a monitored object 14. Electrical leads 16 hardwire sensor 12 to a controller 18. In one embodiment, controller 18 is a computer operating a monitoring program.

Monitored object 14 is any two- or three-dimensional object having a system parameter or characteristic necessary or desirable for monitoring. Such system characteristics include but are not limited to temperature, residual strain, surface crack initiation and growth, and forces such as pressure or impact forces. Monitored object 14 may be made of any material, including, but not limited to, metal, ceramic, plastic, glass, or combinations of these materials. In one embodiment, monitored object 14 is a gas turbine engine blade. The gas turbine blade may be made from a nickel-based, iron-based, cobalt-based, chrome-based, niobium-based, molybdenum-based, copper based, titanium-based, or aluminum-based alloy, a ceramic composition, or other pure metal or composite material. In another embodiment, monitored object 14 is a catalytic converter for an automobile internal combustion engine exhaust system. The outer shell of a catalytic converter is formed of a material capable of resisting under-car salt, temperature and corrosion. Ferritic stainless steels including grades SS-409, SS-439, and SS-441 are typical, but other materials, including, but not limited to, aluminum coated steel and carbon steel are also appropriate. The material chosen for monitored object 14 need not have particular electrical conductive properties or insulating properties for use with monitoring system 10, although such properties may be desirable for other reasons.

Sensor 12 is any sensor formed from thin films and capable of monitoring system characteristics. In one embodiment, sensor 12 is a thermistor, but other sensors are also suitable, including, but not limited to, thermocouples, resistive temperature devices, strain gauges, and pressure sensors. The particular type of sensor chosen is, of course, determined by the system characteristic desired to be monitored.

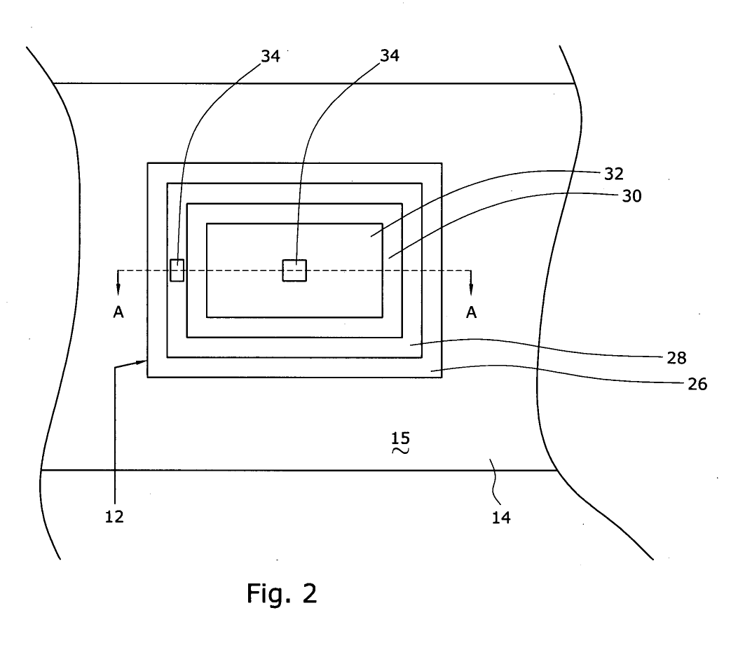

Shown in FIG. 2 is an enlarged schematic top view of one embodiment of ssensor 12. Sensor 12 in this embodiment is a thermistor. As seen more clearly in FIG. 2A, sensor 12 includes several sandwiched layers: a first conductive layer 28, a thermistor layer 30, and a second conductive layer 32. First conductive layer 28 and second conductive layer 32 are preferably made from platinum, although any conductive material is suitable. For example, first conductive layer 28 and second conductive layer 32 may be made from materials including, but not limited to silver, palladium, gold, platinum, or combinations or blends of these materials. Also, first conductive layer 28 may be made of a first conductive material and second conductive layer 32 may be made from a second, different conductive material. First conductive layer 28 may also serve as a diffusion barrier between thermistor layer 30 and the substrate (e.g., monitored object 14 or an optional bondcoat layer 26, described in further detail below) to keep their respective properties constant or to act as an adhesion layer. Conductive layer 32 can also be designed to prevent thermistor layer 30 from interacting with the operating environment or the protective coating that may be placed over it, also covering the whole hardware surface (i.e., the case where the sensor is embedded under the protective coating.)

Thermistor layer 30 is preferably made from a thermistor material (i.e., a semiconductor material whose resistance is a function of temperature) whose properties are stable at high temperatures, so that sensor 12 may function in a high temperature environment. Thermistor layer 30 is preferably yttrium chromite (YCrO₃), although other materials suitable for thermistor layer 30 include, but are not limited to semiconductive metal oxides, rare earth chromites, titanates, in particular ruthenium oxide, lanthanum chromite, lead zirconium titanate, and (Mn, Co, Ni, Ru)₃O₄.

An optional protective or bondcoat layer 26 may be disposed between first conductive layer 28 and the surface 15 of monitored object 14 to minimize chemical interaction and/or provide better adhesion between the materials of monitored object 14 and first conductive layer 28, depending upon the materials used to make monitored object 14 and first conductive layer 28. For the purposes of example only, monitored object 14 in one embodiment is a gas turbine engine blade made from a nickel-base alloy. Monitored object 14 includes a protective layer made from alumina (Al₂O₃) so that first conductive layer 28 made from platinum will adhere properly to surface 15.

To keep the electrical properties constant during operation, a glazing or glassing layer (not shown) may be desirable. When glazing or glassing over sensor 12 is advantageous, these glazing layers can also be direct written over sensor 12 or over second conductive layer 32 and covering thermistor layer 30. Appropriate materials for the glaze layer include, but are not limited to, thermally protective materials such as yttria stabilized zirconia, carbides, alumina, and magnesium oxide. Depending oh the operating environment, it may also be necessary to place another harsh environment protective layer by direct write deposition on sensor 12 and/or the glaze layer.

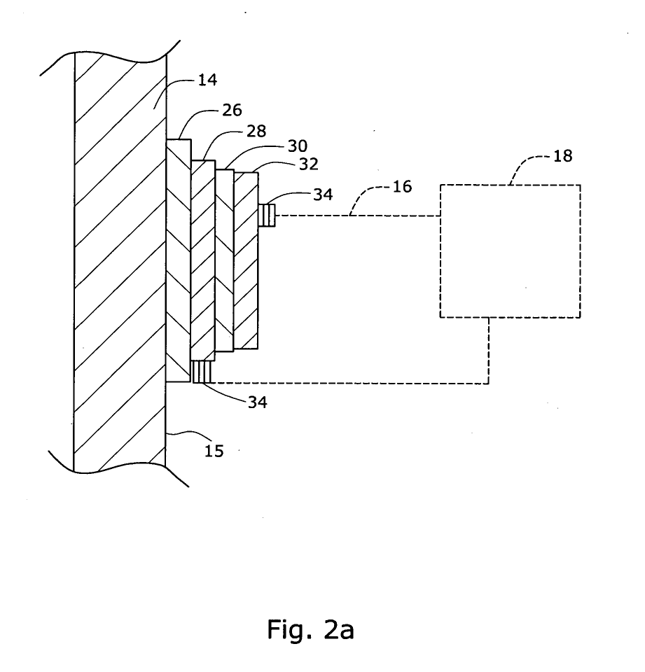

In one embodiment, each of layers 26, 28, 30, 32 is a thin film deposited onto the monitored object 14 using a direct writing technology. Typically, each of layers 26, 28, 30, 32 has a thickness of about 1 to about 300 micrometers, depending upon the actual direct writing method used to manufacture the layers. Examples of known direct write technologies include dip pen nanolithography, micropen or nozzle systems, laser particle guidance systems, plasma spray, laser assisted chemical vapor deposition, ink jet printing, and transfer printing, any of which may be adapted for use in a sensor manufacturing system 40, as shown in FIG. 3. An exemplary discussion of the manufacturing steps follows with particular reference to a micropen-based direct write deposition system as depicted in FIG. 3; however, those skilled in the art will readily recognize that any direct write technology may be adapted for use in the manufacturing process.

FIG. 3 illustrates a schematic view of a sensor manufacturing system 40 according to one embodiment of the invention. Sensor manufacturing system 40 is a direct write deposition system of the micropen variety. Again, while the embodiment shown includes a micropen or nozzle type technology, any direct write system known in the art can be used as an embodiment of the invention. Micropens and similar pen-type deposition systems are known in the art and operate similar to a syringe in that pen 46 draws or deposits a line of metal or ceramic slurries or “inks” onto a substrate material by forcing the ink through a nozzle. The nozzle inner diameter usually ranges from 25 micrometers to 600 micrometers. Pen 46 produces a deposit ranging from 1-600 micrometers in width and 0-10 micrometer in thickness per pass of pen 46. These values are controlled by the parameters programmed to the writing software as well as by the rheology of the ink employed. Pen 46 writes the line at a speed of about 1.27 millimeters per second to 1500 millimeters per second. Pen 46 moves generally vertically (i.e., in the direction of the z-axis) with respect to object 14, but is able to write over complicated topography so the shape of object 14 is not limited. Such pen systems are available commercially, for example, from Sciperio, Inc. of Stillwater, Okla. Commercially-available systems may require modification in order to write on complex topographies. Such a modified pen system is described in detail in commonly-owned, co-pending U.S. application Ser. No. 10/622,063, filed on Jul. 10, 2003, the disclosure of which is incorporated herein by reference.

The ink used in manufacturing system 40 is a metallic or ceramic slurry that includes at least a powder and a solvent. The powder has a grain size of a few nanometers to about 350 micrometers, preferably no more than about 100 micrometers. Preferably, the grain size has a distribution with good fill factor for the densification step. The powder is mixed in a liquid solvent medium such as alcohol, terpineol, or water. The liquid solvent medium may contain binders such as starch or cellulose, surfactants to promote better wetting of the powder mixture on the substrate, or a rheology modifier to regulate the viscosity of the ink as known in the art. The ink typically has a toothpaste-like consistency to reduce spreading of the line prior to hardening. The ink may be mixed in any mixer known in the art, such as a rotating canister, high-speed blender, ribbon blender, three-roll mill, or shear mixer.

Pen 46 is fed ink from an ink source 50. Ink source 50 is a container or vessel that includes a pump, rotator, or similar expulsion means to force ink through a conduit 52 into pen 46. Ink source 50 also preferably includes a mixing component to maintain the consistency of the ink held therein. Further, multiple ink sources may be connected to a single pen in order to produce lines of different materials without having to stop the process to change the ink source.

Sensor manufacturing system 40 incorporates a platform 42 that can translate in the horizontal plane, i.e., in the x-y plane. An object 14 whose temperature is to be monitored in situ is held onto platform 42 by a clamp 44. Clamp 44 may be any clamping device known in the art, such as a spring clamp, vise grip, or similar mechanism. Clamp 44 may be automated to open and close according to a predetermined manufacturing schedule. Consequently, object 14 may be moved in the horizontal plane during manufacturing to facilitate the placement of sensor 12 (shown in FIG. 1) thereupon.

A direct write controller 48 controls the depositing process. Direct write controller 48 is in this embodiment a computer operating a CAD/CAM program. Direct write controller 48 regulates the vertical motion of pen 46, the rate at which ink is expressed from pen 46, and the translation of platform 42 in the horizontal plane.

Referring to FIGS. 2 and 3, the manufacturing steps for producing monitoring system 10 are now described with particular description for the manufacture of a three-layer thermistor having an yttrium chromite layer sandwiched between two layers of platinum. Those skilled in the art will recognize that other sensors can be manufactured in a similar manner without departing from the scope of the invention.

Alumina powder used to form protective layer 26 is provided. The alumina powder is mixed with a solvent and a binder in a mixer to form a pasty alumina ink. The alumina ink is introduced into ink source 50. An object 14 such as a gas turbine engine blade or a catalytic converter is provided and positioned on platform 42 and secured thereupon by clamp 44. Direct write controller 48 signals ink source 50 to dispense the alumina ink through ink conduit 52 and into pen 46. Pen 46 writes a line or line pattern of alumina ink onto object 14. Ink source 50 and pen 46 are then cleared of alumina ink. The alumina ink is then preferably dried, either in an oven or using a localized heating source.

Next, platinum powder used to form first conductive layer 28 (as shown in FIGS. 2, 3) is provided. The platinum powder is mixed with a solvent and a binder in a mixer to form a pasty platinum ink. The platinum ink is introduced into ink source 50. Direct write controller 48 signals ink source 50 to dispense the platinum ink through ink conduit 52 into pen 46. Pen 46 writes a line or line pattern of platinum ink onto the line of dried alumina ink. Ink source 50 and pen 46 are then cleared of platinum ink. Preferably, the platinum ink is allowed to dry at ambient conditions overnight.

Yttrium chromite powder is then provided to form thermistor layer 30 (as shown in FIGS. 2, 3). The yttrium chromite powder is mixed with a solvent and a binder in a mixer to form a pasty yttrium chromite ink. The yttrium chromite ink is introduced into ink source 50. Direct write controller 48 signals ink source 50 to dispense the yttrium chromite ink through ink conduit 52 into pen 46. Pen 46 writes a line or line pattern of yttrium chromite ink onto the line or line pattern of platinum ink. Ink source 50 and pen 46 are then cleared of yttrium chromite ink.

Next, a platinum powder used to form second conductive layer 32 (as shown in FIGS. 2, 3) is provided. The platinum powder is mixed with a solvent and a binder in a mixer to form a pasty platinum ink. The platinum ink is introduced into ink source 50. Direct write controller 48 signals ink source 50 to dispense the platinum ink through ink conduit 52 into pen 46. Pen 46 writes a line or line pattern of platinum ink onto the line or line pattern of yttrium chromite ink. Again, preferably, the platinum ink is allowed to dry overnight in ambient conditions.

Object 14 is removed from platform 42 and inserted into an oven. Object 14 is then preferably baked at 1550 degrees centigrade for one (1) hour in air and then one (1) hour in Ar at the same temperature to co-sinter layers 26, 28, 30, 32 together. It should be apparent to those skilled in the art that baking times, temperatures, and media may vary according to the materials used for object 14 and/or any of layers 26, 28, 30, 32.

Object 14 is then cooled and repositioned upon platform 42. Clamp 44 secures object 14 to platform 42. Preferably, electrical contacts 34 are formed by joining commercially available 5 millimeter diameter platinum wires to first and second conductive layers 28, 32 using the same platinum paste used in the formation of those layers 28, 32 to provide a secure electrical connection.

A second end of electrical leads 16 is soldered to monitoring controller 18, thereby establishing a hardwired link between sensor 12 and controller 18. An optional coating of silicone or epoxy is applied to monitoring system 1 O by dipping, brushing, or similar application as known in the art. Additionally, system 10 is preferably aged in a control oven to provide a characteristic profile for sensor 12. Finally, monitoring system 10 is packaged and shipped.

As will be readily apparent to those skilled in the art, many of the steps described above may be condensed or eliminated. For example, all inks may be prepared simultaneously. Also, several ink sources may be used in parallel so that the ink sources need not be cleared after each application. Further, if no protective layer is necessary, all steps associated therewith may be eliminated, and first conductive layer 28 may be deposited or direct written onto surface 15 of object 14.

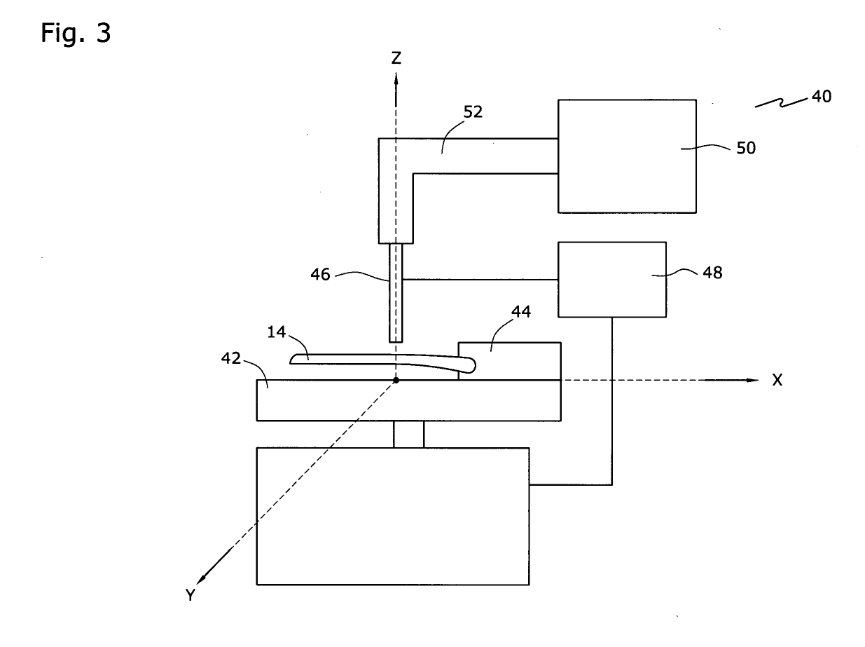

An alternate embodiment of monitoring system 110 is shown in FIG. 4. This system is identical to the monitoring system 10 described above with respect to FIG. 1, except that controller 18 remotely controls sensor 12. Leads 16 connect sensor 12 to circuitry 20. Circuitry 20 collects data from sensor 12 and transmits that data to remote controller 18 via a transceiver 22 powered by a power source (not shown) disposed on object 14. Remote controller 18 also includes a controller transceiver 24 to receive the signal from sensor transceiver 22. The signal can be of any type known in the art, such as radio frequency, microwave, and optical signals.

To manufacture monitoring system 110, a similar process is followed as described above with respect to the monitoring system shown in FIG. 2. However, the direct write system can be used to write circuitry 20 and the antenna for sensor transceiver 22 onto object 14. Metallic or ceramic materials or combinations can be used to make these parts based on the performance requirements, as known in the art.

Multiple temperature measuring devices such as a thermocouple or a thermistor, or combinations, can be processed and packaged (i.e., electrically connected, protective layers processed, antenna deposited, etc.) as a separate product or onto the preferred object or hardware. Multiplicity can improve the reliability of the whole sensor system, and the use of direct write technologies provide simplified design, higher ruggedness, ease of manufacture, and packaging.

### EXAMPLE

Following the preferred direct write and co-sintering procedure described above, several three-layer sandwich-printed and co-sintered thermistors were manufactured. The direct write deposition technology used was a robotic micropen system depositing onto an alumina substrate. All sensors were manufactured using platinum for the conductive layers (e.g., first and second conductive layers 28, 32 as described with respect to FIGS. 2, 3) and an yttrium chromite mixture as the thermistor layer (e.g., thermistor layer 30 as described with respect to FIGS. 2, 3). The layers were co-sintered in air for one (1) hour and then Ar for one (1) hour. A platinum ink was used to direct write the leads. The sensors were made in varying sizes. Table 1 lists the resistance of each of these thermistors at 25 degrees centigrade.

TABLE 1
Inventive Thermistor Designation and Resistance at 25° C.

| Designation | Resistance at 25° C. (kohms) |
|---|---|
| IS#1 | 52 |
| IS#2 | 145 |
| IS#3 | 19 |
| IS#4 | 540 |

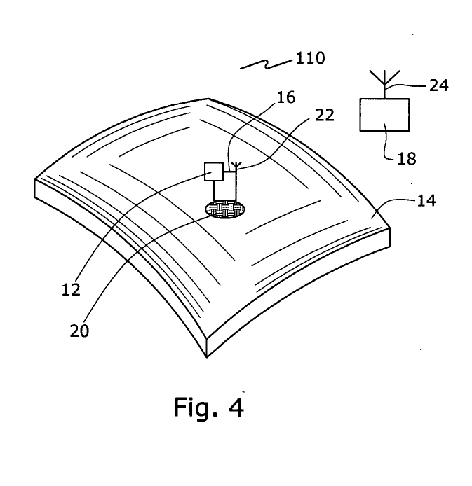

Each of these thermistors was calibrated by subjecting it to a controlled heating in order to determine the resistance at various temperatures. Further, an yttrium chromite thermistor made in a conventional manner and having a resistance of 172 kohms at 25 degrees centigrade was heated in the same manner as a control. The conventional thermistor is made using the labor-intensive pressing, molding, and grinding process previously discussed. FIG. 5A is a graph plotting the natural logarithm of the resistance versus the inverse temperature for each of the inventive thermistors and the conventional thermistor. The slope of each of the plotted curves in FIG. 5A is a parameter known as the β value. The β value is basically a sensitivity index of the thermistor material, and, therefore, should be similar in all yttrium chromite thermistors. As seen in FIG. 5A, the β value is substantially the same for all of the tested thermistors, indicating that the direct write manufacturing process does not alter the thermistor capabilities.

Furthermore, IS#1 was retested approximately one (1) month after the initial test to determine the stability of the inventive thermistor. As shown in FIG. 5B, which plots the resistance in ohms of IS#1 versus temperature in degrees centigrade, the resultant curves are the same. This confirms the repeatability of measurement of the inventive sensors.

The previously described embodiments of the invention have many advantages, including the simplification of the manufacturing process for sensors in that the process may all take place on the same line. Additionally, adding materials to the products, such as additional circuitry and antennas may be accomplished without having to change assembly lines. Further customization of products is simplified, such as changing materials for layers of the sensor, as new inks are easily mixed and added to the direct write system.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by united states letters patent is:

1. A method for making a sensor comprising:
(i) depositing a first layer of the sensor onto a substrate using a direct write technology;
(ii) depositing a second layer of the sensor upon the first layer using a direct write technology;
(iii) depositing a third layer of the sensor upon the second layer using a direct write technology; and
(iv) sintering the first, second, and third layers together.

2. The method of claim 1, wherein the direct write technology is selected from a group consisting of a robotic pen, a micropen, a dip pen, laser particle guidance, plasma spray, laser assisted chemical vapor deposition, ink jet printing, and transfer printing.

3. The method of claim 1 further comprising:
(v) mixing a first powder with a first solvent and a first binder to form a first ink for depositing as the first layer;
(vi) mixing a second powder with a second solvent and a second binder to form a second ink for depositing as the second layer;
(vii) mixing a third powder with a third solvent and a third binder to form a third ink for depositing as the third layer;
(viii) mixing a fourth powder with a fourth solvent and a fourth binder to form a fourth ink;
(ix) forming electrical contacts by direct writing the fourth ink onto at least a portion of the sintered layers;
(x) connecting the contacts to a controller; and
(xi) applying a coating layer.

4. The method of claim 3, wherein at least one of the first powder, the third powder, and the fourth powder comprises a material having electrically conductive properties.

5. The method of claim 4, wherein the first powder comprises platinum.

6. The method of claim 4, wherein the third powder comprises platinum.

7. The method of claim 4, wherein the fourth powder comprises an electrically conductive material.

8. The method of claim 7, wherein the fourth powder includes a metal selected from the group consisting of silver, gold, platinum, and palladium.

9. The method of claim 3, wherein the fourth powder comprises a glaze material.

10. The method of claim 9, wherein the fourth powder includes a material selected from the group consisting of yttria stabilized zirconia, carbides, alumina, and magnesium oxide.

11. The method of claim 3, wherein the second powder is a material whose electrical resistance is a function of temperature.

12. The method of claim 11, wherein the properties of the second powder are stable at high temperatures.

13. The method of claim 12, wherein the second powder comprises a rare earth chromite.

14. The method of claim 13, wherein the second powder comprises yttrium chromite.

15. The method of claim 3, further comprising aging the sensor to obtain a characteristic profile prior to connecting the leads to the controller.

16. The method of claim 3, wherein the electrical contacts are hardwired to the controller.

17. The method of claim 3, wherein the electrical contacts are remotely connected to the controller through a transceiver.

18. A method for making a temperature sensor comprising:
(i) providing an object to be monitored by the sensor;
(ii) direct writing a first conductive layer upon the object;
(iii) direct writing a thermistor layer onto the first conductive layer;
(iv) direct writing a second conductive layer onto the thermistor layer; and
(v) sintering all of the layers together.

19. The method of claim 18 further comprising direct writing a protective layer upon the object prior to direct writing the first conductive layer, such that the first conductive layer is disposed upon the protective layer.

20. The method of claim 18, wherein the object is a turbine engine blade.

21. The method of claim 18, wherein the object is a catalytic converter.

22. The method of claim 18, wherein the sintering is performed in air.

23. The method of claim 18, wherein the sintering is performed in argon gas.

24. The method of claim 18, wherein the sintering has an applied temperature of 1550 degrees centigrade.

25. The method of claim 18 further comprising:
(vi) direct writing conductive leads onto the sensor; and
(vii) connecting the leads to a controller.

26. The method of claim 18 further comprising:
(vi) direct writing circuitry onto the object; and
(vii) connecting the circuitry to the sensor.

27. The method of claim 18 further comprising direct writing a transceiver onto the object.

28. A system for real-time monitoring of a system characteristic comprising:
a three-dimensional object to be monitored;
a thermistor formed upon the object using a direct write process; and
a controller functionally connected to the thermistor.

29. The system of claim 28, wherein the object is a turbine engine blade.

30. The system of claim 28, wherein the object is a catalytic converter.

31. The system of claim 28, further comprising a protective layer disposed between the object and the thermistor to prevent chemical interaction between the material of the object and the material of the thermistor.

32. The system of claim 28, wherein the thermistor is hardwired to the controller.

33. The system of claim 28, further comprising circuitry direct written on the object for collecting data from the thermistor;
a transceiver direct written on the object for generating a signal containing the data; and
a remote controller for receiving the signal.
